(19) United States
(12) Patent Application Publication
(10) Pub. No.: US 2019/0293180 A1
(43) Pub. Date: Sep. 26, 2019

(54) EMBODIMENT INTRODUCED IN CRANKCASE GASKET FOR MULTIPLE SEALING

(71) Applicant: Sabo Industria E Comercio De Autopeças S.A., São Paulo (BR)

(72) Inventor: Lourenço Agnello Oricchio, JR., São Paulo (BR)

(21) Appl. No.: 16/283,461

(22) Filed: Feb. 22, 2019

(30) Foreign Application Priority Data
Mar. 23, 2018 (BR) 20 2018 005926-8

(51) Int. Cl. F16J 15/10

(52) U.S. Cl. CPC F16J 15/104; F16J 15/102

(57) ABSTRACT

A crankcase gasket for use in automotive applications, the gasket including an aluminum brace having cutouts at or near its corners, a sealing layer formed on the brace, and scaling flaps located at least partially within the cutouts for sealing interstices occurring in or at intersections of the engine block, the crankcase, and the front and rear caps of an internal combustion engine. The sealing flaps may each include: a first area of extending scaling layer contained within the cut out; a second extending area extending from a first edge of the first extending area along an adjacent inner edge of the aluminum brace adjacent to the cut out; grooves or ridges formed in the first and second extending areas of the rubber flap, the grooves or ridges providing for sealing within interstices; and one or more barriers or stops disposed within the first and/or second extending areas of the rubber flap to support positioning and/or securing of each rubber flap relative to an interstice.

The present application claims the benefit of priority of applicant's co-pending Brazilian Application No. 20 2018 005926-8 filed on Mar. 23, 2018, the entire contents of which are incorporated herein by reference.

### FIELD OF THE TECHNOLOGY

Aspects of the present disclosure relate to a crankcase gasket, and in particular to a gasket this is embodied in a single part that provides sufficient sealing of interstices in the junction zone between the block, the crankcase and the front and rear caps of an internal combustion engine.

### BACKGROUND

In an internal combustion engine, the assembly of the engine block, crankcase and front and rear engine caps defines interstices that favor the oil leakage. The sealing of such interstices, is usually performed by paper gasket which seals between the block and the crankcase, and by silicone injections that seal between the caps, block and crankcase. This construction of sealing meets its purpose, but presents a downside of the silicone injection obtainment is a relatively hard task in the engine assembly line.

In another possibility, this sealing of the three-part junction area: block, crankcase and cap, is performed through a crankcase gasket with controlled compression, formed: by an aluminum brace; by vulcanized rubber layer in the aluminum brace; by cut outs performed in inner edge segments of the corners of the brace disposed in correspondence to the junction area of the three parts: block, crankcase and cap; and by the sealing rubber layer areas, that are exposed by the cut outs of the aluminum brace, rubber areas such responsible for the sealing itself. This sealing properly meets the sealing function in the junction of the block, crankcase and cap. However, this sealing presents an inconvenient from area of the exposed rubber layer, responsible for the sealing itself having its own configuration and, therefore, limited efficiency due to the cut out configurations and the aluminum brace itself, in which this is performed.

For this reason, it has been desirable new solutions for the sealing of the junction area of the three parts: block, crankcase and cap.

### SUMMARY

Aspects of the present disclosure overcome the inconvenient of related art techniques relating to the interstices sealing in the junction of the block, crankcase, and flap of internal combustion engineer of motor vehicles.

Other aspects of the present disclosure provide a solution that, in addition to overcoming the issues in the related art techniques, incorporates simple construction and manufacture.

Yet other aspects of the present disclosure provide a solution that, in addition to overcoming issues with related art techniques, includes simple construction and manufacture that also eases assembly in the internal combustion engine production line.

Another aspect of the present disclosure provides a solution that, in addition to overcoming issues with related art techniques of simple construction and enabling of ease of manufacture, also present low costs for production, assembly in the engine, use, and maintenance.

In view of the above mentioned benefits and advantages, as well as others, aspects of the present disclosure provide various features for a crankcase gasket that provides for multiple sealing features and uses, the crankcase gasket including controlled compression features that include an aluminum brace; one or more vulcanized sealing rubber layers in the aluminum brace; one or more cut outs in the inner edge of the brace and located in its corners, which correspond to one or more areas of junction of the block, crankcase, and/or a cap; and by one or more corner flaps for providing multiple sealing features, each flap being formed: by first area confined in the aluminum brace cut out; and by the second free area prolonged from the first area and projected in relation to the inner edge of the aluminum brace; said corner flap, inner for multiple sealing, still formed by the first and second areas for multiple sealing having surfaces provided of grooves and barriers (stops) adequate that assure the sealing.

Among other things, the construction features with regard to the corner sealing flap provide an efficient sealing of interstices in the junction area of the block, crankcase, and caps, with the advantage of avoiding the need for use of multiple components for the gasket, as is typical at the joint of paper gasket and silicone injection type gaskets of the related art. Aspects of the present disclosure thus provide, among other things, the advantage of the feature that the corner sealing flap, in being provided in the second sealing area that extends from the first area and projects in relation to the inner edge of the aluminum brace, also avoids the limited efficiency that would otherwise be expected for the aluminum brace cut out area.

Aspects of the present disclosure also provide, among other things, the advantage of the gasket not interfering with the assembly of an engine during operation of the engine assembly line.

In addition, aspects of the present disclosure provide, among other things, the advantage of avoiding the necessity of using construction and manufacture operations that have difficult levels of assembly complexity and costs relative to those of other crankcase gaskets of the related art.

Additional advantages and novel features of these aspects will be set forth in part in the description that follows, and in part will become more apparent to those skilled in the art upon examination of the following or upon learning by practice of the disclosure.

### BRIEF DESCRIPTION OF THE FIGURES

The accompanying drawings, which are incorporated into and constitute a part of this specification, illustrate one or more example aspects of the present disclosure and, together with the detailed description, serve to explain their principles and implementations.

FIG. 1 shows a cross-sectional view of an example crankcase gasket with a blow up of detail for a corner flap portion, in accordance with aspects of the present disclosure.

FIG. 2 shows a detailed view of a portion of gasket emplaced with an example engine block and crankcase flange, in accordance with aspects of the present disclosure.

FIG. 3 shows a detailed view of various features of an example crankcase gasket corner, in accordance with aspects of the present disclosure.

FIGS. 4 to 7 show views of various features and portions of an example corner flap, in accordance with aspects of the present disclosure.

FIGS. 8A and 8B show details of various features in the region of the junction of the block, crankcase, and cap, where the gasket corner flap may be emplaced, in accordance with aspects of the present disclosure.

FIG. 9 shows various aspects of an example corner flap in accordance with the gasket of FIG. 8B.

### DETAILED DESCRIPTION

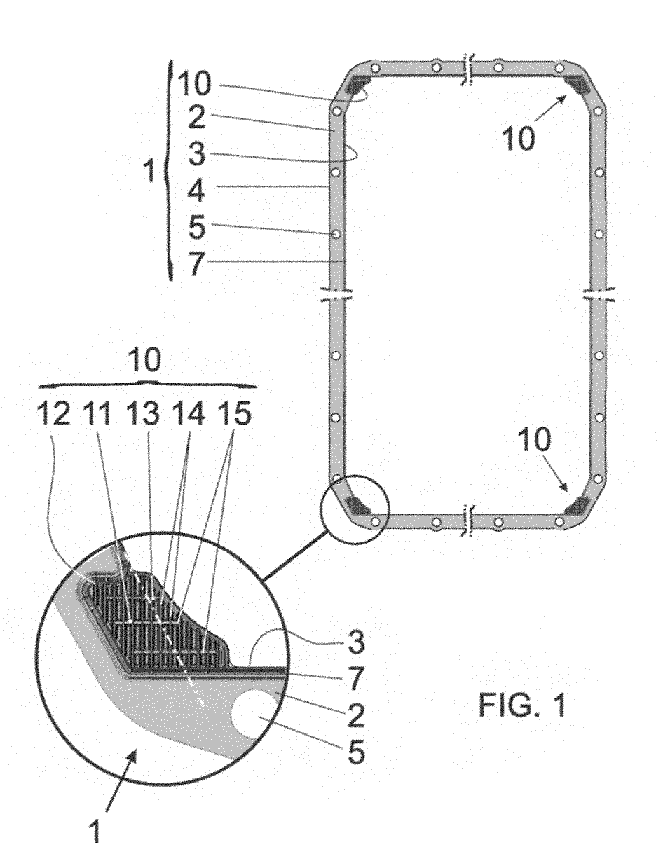

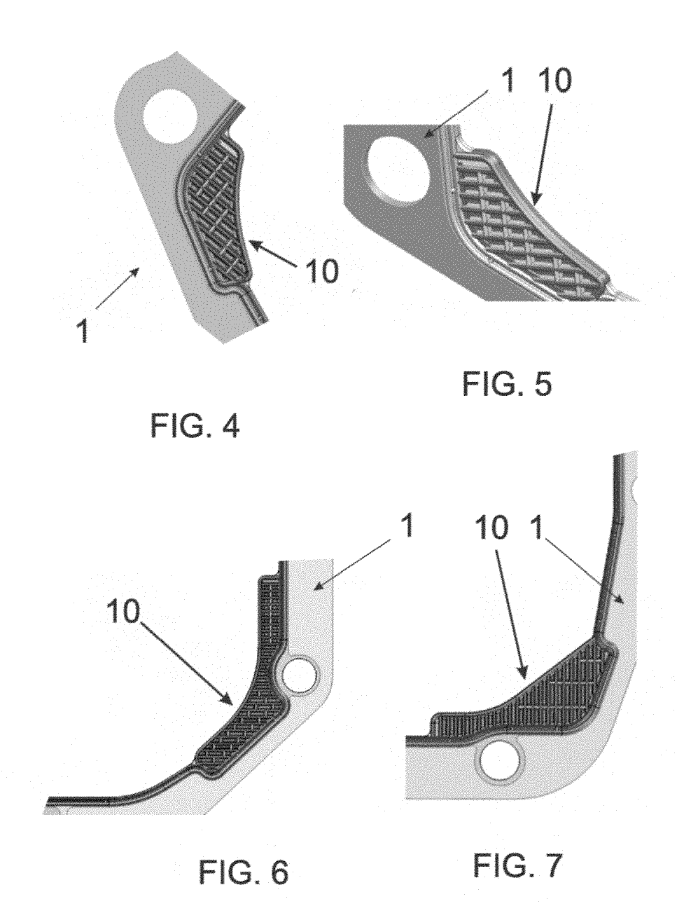

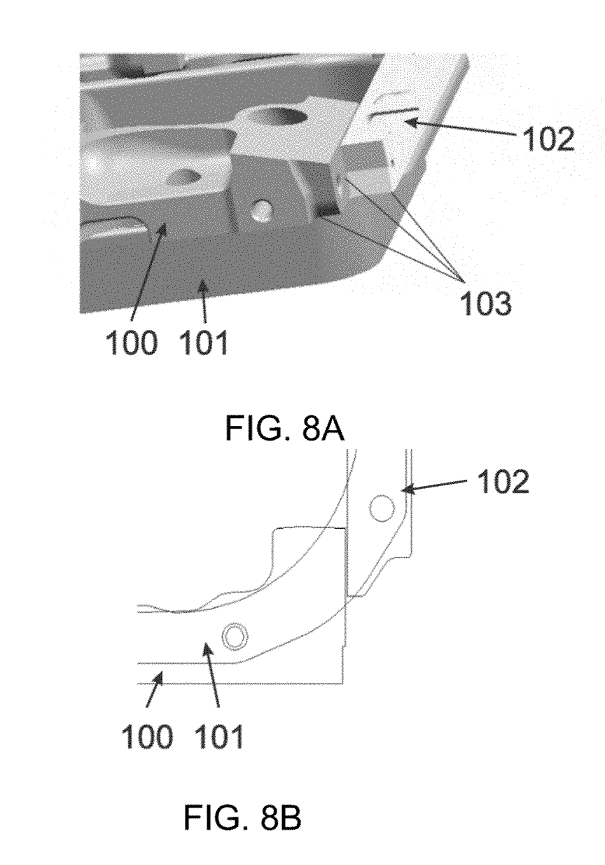

As shown in FIGS. 1-9, an example crankcase gasket 1 in accordance with aspects of the present disclosure may provide for the sealing of interstices 103 (FIG. 8A) formed in the junction zone of the engine block 100, crankcase 101, and front and rear caps 102 of an internal combustion engine (FIGS. 8A and 8B).

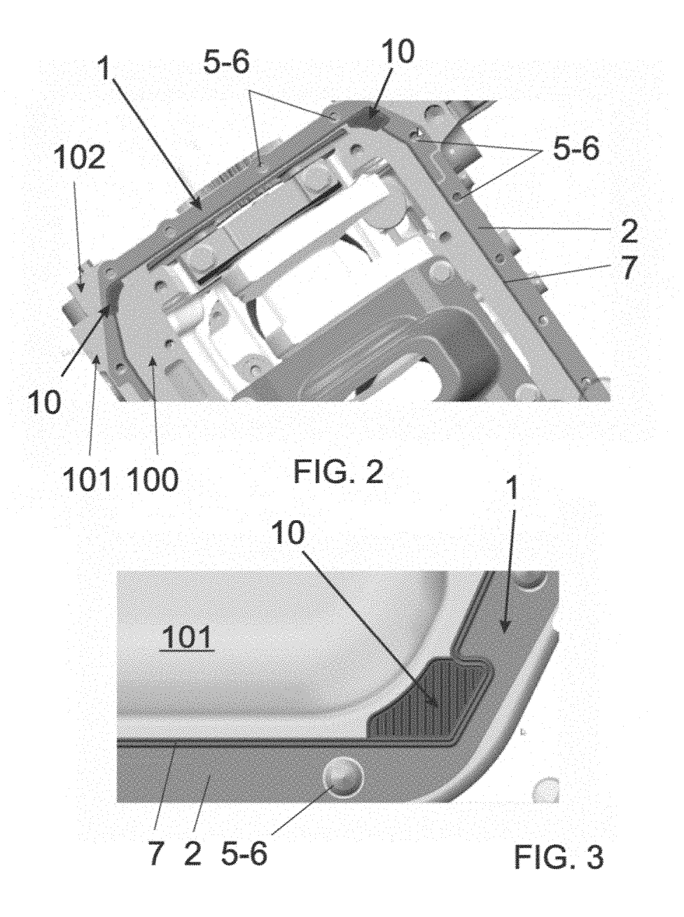

In one example implementation, the crankcase gasket 1 is referred to herein as a control compression type crankcase gasket, which is formed with an aluminum brace 2 in the general shape of a closed ring having an inner edge 3, an outer edge 4, and one or more bores or other openings 5 for receiving securing features 6, such as screws or bolts (FIGS. 2 and 3), which may be used for securably locating the gasket 1 between the block 100 and the crankcase flange 101, as shown in FIGS. 2 and 3. The crankcase gasket 1 may be formed, for example, with a vulcanized sealing rubber layer 7 emplaced on in the brace 2.

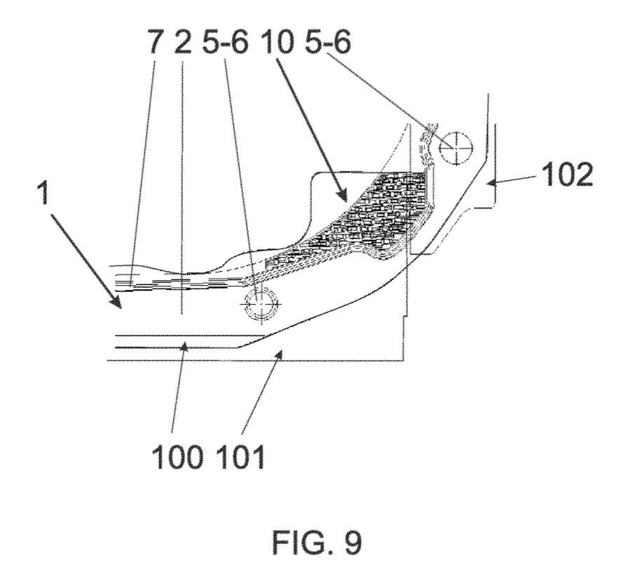

In one example implementation, as shown in greater detail in the close-up portion of FIG. 1, the crankcase gasket 1 may be provided with one or more flaps 10, which may comprise rubber, for example, arranged so as to provide multiple sealing features. Such flaps 10 may, for example, be located in the respective inner corners of the aluminum brace 2, and each flap 10 may include: 1) a first area 11 that extends from the sealing rubber layer 7 and lying within the cut out portion 12 of the aluminum brace 2; 2) a second area 13 extending from the indicated dotted line from the first area 11 in a direction inwardly from the inner edge 3 of the aluminum brace 2, including along the region of the edge 3 adjacent to the cut out portion 12; 3) grooves or grooved features 14 on or comprising at least a portion of the first area 11 and the second are 13 of the flap 10; and 4) one or more barriers or stops 15, such as extending rubber protrusions, and/or other features for securely positioning and/or impeding sliding movement of the flap 10 relative to one or more surfaces that may abut the flap 10, such as the surface of an adjacent block 100, crankcase 101, and/or cap 102 (FIGS. 8A-9), wherein the barriers or stops 15 may be disposed between or adjacent to the portion of the flap 10 having grooves 14; and wherein the barriers 15 are arranged in an adequate manner according to the sealing needs relative to the abutting surface(s).

The example crankcase gasket 1 as shown, for example, in FIGS. 2 and 3, may be emplaced so as to be located between the engine block 100 and the crankcase flange 101 upon assembly therewith, with the bores 5 being located so as to receive any fixing screws or bolts 6 and such that the flaps 10 of the gasket 1 are located so as to be disposed within the junction zone of the block 100, crankcase 101, and caps 102, with the sealing layer 7 and the flaps 10 being located such that all interstices 103 are sealably defined between the block 100 and the crankcase 101 and between the caps 102 and the crankcase 101 and block 100, as shown in FIGS. 8A-9.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. (canceled)

2. A crankcase gasket, comprising:
a ring-shaped aluminum body including:
an inner extending edge;
an outer extending edge;
at least one corner area within the inner extending edge, each of the at least one corner area having a corresponding cut out extending between a first proximal inner edge portion and a second proximal inner edge portion of the inner extending edge; and
a sealing material formed about or upon the aluminum body; and
at least one flap located proximal to each of the at least one corner, wherein each of the at least one flap includes:
a first extending flap area extending within the cut out area of the corresponding at least one corner to a border aligned with an extending direction of the inner extending edge of the first proximal inner edge portion of the aluminum body;
a second extending flap area, the second extending flap area extending between the border of the first extending flap area and the extending inner edge of the second proximal inner edge portion of the aluminum body;
wherein each of the first extending flap area and the second extending flap area include a plurality of grooves or ridges to facilitate sealing contact with an adjacent sealed surface; and
wherein at least the first extending flap area includes at least one barrier or stop for securely positioning the flap relative to the adjacent sealed surface.

3. The gasket of claim 2, wherein the aluminum body further includes at least one bore extending therethrough.

4. The gasket of claim 2, wherein a securing device is receivable within each of the at least one bore to sandwichably secure the gasket between a plurality of engine components.

5. The gasket of claim 4, wherein the plurality of engine components include at least two selected from a group consisting of a block, a crankcase, and a cap.

6. The gasket of claim 2, wherein the sealing material comprises vulcanized rubber.

7. The gasket of claim 4, wherein each of the at least one bore is configured to receive a securing element for sandwichably securing the gasket between at least two surfaces, each of the at least two surfaces extending upon at least one of the plurality of engine components.

8. The gasket of claim 2, wherein the plurality of grooves or ridges form a lattice pattern.

9. The gasket of claim 2, wherein each of the at least one barrier or stop comprises a protrusion of the sealing material.

10. The gasket of claim 2, wherein at least one of the plurality of engine components includes an interstice formed by a portion thereof.

11. The gasket of claim 10, wherein the interstice is formed by at least a first portion in a first one of the plurality of engine components and a second portion formed a second one of the plurality of engine components.

12. The gasket of claim 10, wherein the plurality of groves or ridges and the at least one barrier or stop sealably abut corresponding portions of the interstice.
